(19) United States
(12) Patent Application Publication
(10) Pub. No.: US 2010/0185455 A1
(43) Pub. Date: Jul. 22, 2010

(54) DYNAMIC WEB HOSTING AND CONTENT DELIVERY ENVIRONMENT

(75) Inventor: Edward D. Miller, Legrand, CA (US)

Correspondence Address: PERKINS COIE LLP, P.O. BOX 1208, SEATTLE, WA, 98111-1208, US

(73) Assignee: Green Networks, Inc.

(21) Appl. No.: 12/687,009

(22) Filed: Jan. 13, 2010

Related U.S. Application Data
(60) Provisional application No. 61/145,480, filed on Jan. 16, 2009.

(51) Int. Cl. G06F 15/16; G06Q 99/00

(52) U.S. Cl. 705/1.1; 709/203

(57) ABSTRACT

A computer system implements a method to establish a computer environment with a plurality of computer systems. Each of the plurality of computer systems can be dynamically added to the computer environment. Web contents can be distributed in real-time among the plurality of computer systems. Upon receiving a Uniform Resource Locator (URL) request from a client system, the URL request is directed to one or more of the plurality of computer systems that are in geographic close in proximity to the client system and contain the requested web contents. The one or more of the plurality of computer systems then transmit the requested web contents to the client system.

### CROSS-REFERENCE TO RELATED APPLICATIONS

This application claims the benefit of U.S. Provisional Application No. 61/145,480, entitled “DYNAMIC WEB HOSTING AND CONTENT DELIVERY ENVIRONMENT”, filed Jan. 16, 2009, and is hereby incorporated by reference.

### FIELD OF THE INVENTION

At least one embodiment of the present invention pertains to a dynamic web hosting and content delivery environment, and more particularly to a system that allow individual computer systems to participate in providing web content distribution and web services.

### BACKGROUND

The Internet is designed based on direct client-to-host communications. To improve its performance and throughput, a web host on the Internet often utilizes content and application delivery networks in serving web contents and web applications. A content and application delivery network can deploy copies of the same web contents to its multiple servers, thereby greatly increasing the number of concurrent users that can access the web host. The content and application delivery network also improves throughputs and availability of the web host. From a client's perspective, any web contents and web applications can be accessed via a Uniform Resource Locator (URL). For example, an Internet user can access a web site by simply typing a URL such as www.cnn.com into the address bar of its web browser. During transmission, the user request may be forwarded, according to the URL, to a server managed by the content and application delivery network. The server, which can be one of the many servers that contain web contents for CNN® web site, can process the user request and respond to the client with the requested contents. Thus, from the end user's perspective, the content and application delivery network is transparent in quickly and seamlessly delivering the requested web content to his browser.

However, to establish such a web content and application delivery network, a large amount of system resources have to be pre-established before the web contents and applications can be distributed and served. For example, a large number of network backbones, dedicated network connections and computer servers have to be strategically implemented across geographic boundaries. Such a dedicated network is not only costly, but also inefficient in serving the fast-changing and unpredictable Internet traffic. When a particular web site receives a sudden surge of web traffic originated from a new geographic area, it is often impractical to immediately deploy a large amount of network and system resources overnight to such area in order to satisfy such traffic surge.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1 illustrates a system environment in which the present invention can be implemented;

FIG. 2 illustrates an exemplary configuration of a dynamic web hosting environment;

FIG. 3 illustrates a flow diagram for setting up a dynamic web hosting environment; and

FIG. 4 illustrates a flow diagram for joining a dynamic web hosting environment.

### DETAILED DESCRIPTION

Methods and systems for a dynamic web hosting and content delivering environment are described. In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments, of the invention.

In one embodiment of the present invention, a dynamic web hosting and content delivering environment can be established with multiple individual computer systems distributed across the Internet. Any individual computer system that is accessible from the web can be dynamically connected and quickly added to the environment. Once becoming a part of the web hosting and content delivery environment, each of the individual computer systems, which can be referred to as a member host, can contribute its spare CPU, memory, storage and network bandwidth to the web hosting environment in serving web contents and providing web services. The dynamic web hosting environment is controlled by a dynamic web hosting manager monitoring the individual member hosts participated in the environment. The web hosting manager also distributes web contents to these member hosts based on the origins of web requests and demands of the web contents and services. Once the dynamic web hosting environment is established, third-party content providers and web sites can subscribe to the various services supported by the environment, thereby allowing their respective contents and services being geographically distributed across the Internet. Further, Internet traffics originated from client computers can be directed to the member hosts in the environment that are geographically close in proximity to the client computers. Therefore, these individual member hosts can act as edge servers for the third-party web sites. The revenue received from the third-party content providers and web sites can be shared among the participating member hosts, providing incentives for additional computer systems to join the dynamic web hosting environment.

In one embodiment, an individual computer system connected to Internet can dynamically join the web hosting environment by signing up with the web hosting manager that is controlling and managing the environment. During signing up, the web hosting manager collects geographic information about the individual computer system and evaluates its CPU, memory, storage, and network capacities. The geographic information can be collected from the IP address of the computer system as well as the Internet Service Provider (ISP) the computer system utilizes. Depending on the spare system resources available in the computer system and the web traffic demands, the web hosting manager can arrange to configure the individual computer system as an edge server, a load-balance or failover server, a server for a cloud network configuration, or a dedicated web hosting or application server, etc. Once web contents and/or web applications are uploaded and configured on the individual computer system, the individual computer system becomes a member host in the dynamic web hosting environment, and is ready for serving user requests.

In one embodiment, a user request based on URL is received from a client computer. URL is a term used for identifying the location of a resource on the web. The user request can be forwarded to the web hosting manager of the dynamic web hosting environment. Various techniques can be utilized to forward such user request, which is intended for a web site identified by the URL, to the web hosting environment. For example, the ISP for the client system can forward the user request, based on DNS configuration, to the hosting manager of the environment. Alternatively, TCP anycast, which is a network addressing and routing scheme, can forward the user request to a destination address of a member host. Further, the hosting manager can utilize URL redirecting to relay the user request to member hosts in the dynamic hosting environment for processing. URL redirecting is a technique for making one piece of information available for multiple URL addresses. Thus, when a user requests for information identified by a first URL, URL redirecting relays the request to a second URL (redirected URL), and responses with the result obtained from the second URL to the user. From the client computer's perspective, the response user received appears to be originated from the first URL. Thus, by utilizing the above or similar techniques, the user request can be routed to the member hosts that can supply the services, and are geographically close in proximity to the client computer, without the client computer acknowledges.

In one embodiment, web content providers and web sites can subscribe to the services supported by the dynamic web hosting environment. Further, there can be different levels of services that are available for content hosting and delivering. For example, for web content providers that require a cloud computing capability, the member hosts in the environment can be clustered together to form such a cloud in providing web services. Depending on the level of service and the amount of contribution to the dynamic web hosting environment, each of the member hosts in the environment can be allocated a share of revenues collected from the third-party content providers and web sites. Such an approach can attract additional individual computer systems to join in the web hosting environment, thereby ensuring adequate and fast deployments in providing on-demand web content hosting and service delivering.

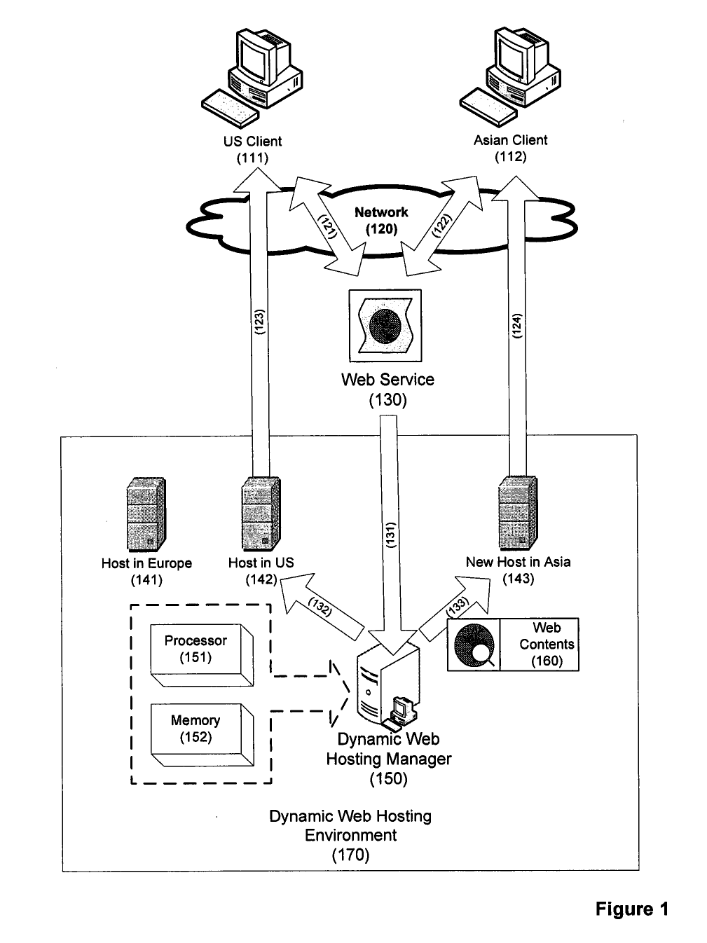

Referring now to FIG. 1, which shows an exemplary networked system environment in which the present invention may be implemented. In FIG. 1, multiple clients 111 and 112 are connected to a network 120. The network 120 may be, for example, a local area network (LAN), wide area network (WAN), metropolitan area network (MAN), global area network such as the Internet, a Fibre Channel fabric, or any combination of such interconnects. Each of the clients 111-112 refers to a computer system or a program from which a user request 121 or 122 may be originated. Such computer systems for the clients 111-112 may be, for example, conventional personal computers (PC), server-class computers, workstations, game consoles, handheld computing/communication devices, cell phones, or similar devices.

In one embodiment, one of the clients, e.g., client 111, initiates a user request 121 to a web service 130 through the network 120. The web service 130 can be a web site on the Internet which provides web contents and services. It can also be a software application system designed to support network communications via various application programming interfaces (APIs). The user request 121 is a network communication designated to a specific recipient. Examples of user request include HTTP requests originated from a web browser application, such as a URL input into a web browser's address bar, or “HTTP Get” or “HTTP Put” messages originated from a HTML form displayed in the web browser. Alternatively, the user request 121 may be originated from a user-invoked or an event-triggered software program running on client 111. By containing URL identifiers such as www.cnn.com, the user request 121 can be delivered via the network 120 to a host identified by the URL. The host can contain a web server application such as Apache® HTTP Server, or Microsoft® Internet Information Server, etc, to process user requests in HTTP. Alternatively, the host may contain customized software programs to handle the received user requests. After performing the requested services, the host returns the requested web contents or responses back to the client 111.

In one embodiment, the host is selected from a dynamic web hosting environment 170 by a dynamic web hosting manager 150 to serve the user request 121. The dynamic web hosting environment 170 contains multiple individual computer systems located across the web. In one embodiment, the multiple computer systems are located across the web based on geographic locations, meaning that each of the individual computer systems is connected to the network 120 at a different geographic location. For example, a computer system 141 can be connected to the network 120 via an Internet Service Provider (ISP) that is located in Europe. And another computer system 142 can be connected to the network 120 from US. All the computer systems in the dynamic web hosting environment 170 are managed by the dynamic web hosting manager 150. Thus, each of the individual computer systems becomes a member host in the dynamic web hosting environment 170. The dynamic web hosting manager 160 manages these member hosts in the environment 170, monitors the client requests such as 121 and 122, as well as distributes web contents among the member hosts 141-143.

In one embodiment, the user requests 121-122 are redirected or forwarded to the dynamic web hosting manager 150. Redirecting means that the user requests, which can be intended for a web site such as www.cnn.com, is directly transmitted to the web hosting manager 150 instead. Forwarding means that a web site such as www.cnn.com can forward whatever user requests it received at the web site to the web hosting manager 150. Further, additional mechanisms can be employed to transmit either the user requests, or the information contained therein to the web hosting manager 150. After receiving the information about the user requests, the dynamic web hosting manager 150 then identifies the origin of these user requests, and determines an optimal member host in the web hosting environment 170 to serve such user requests. The web hosting manager 150 then informs the selected member host about the user requests, for the member host to process the user requests and respond to the clients via responses 123-124. Further, more than one web hosting managers 150 can be deployed in the web hosting environment 170 to balance the loads of user requests received. The user requests can also be transmitted via DNS configurations or other network techniques such as IP anycast to some or all of the web host managers.

In one embodiment, the member host is optimally selected based on various criteria. The criteria for selecting an optimal member host include geographic location evaluation, network transmission cost evaluation, etc. In geographic location evaluation, all member hosts' geographic locations are evaluated with respect to the client's location in order to find the optimal host that is geographically closest to the client. The geographic location can be derived from the member host and the client's IP address. It can also be derived from the ISP that is serving the member host or the client. For example, once determined that the client 111 is located in US, the web hosting manager 150 can select a member host that is either located in US, or is located in a place that is the closest for serving contents to the client 111. Thus, between a host 141 in Europe and a host 142 in US, host 142 can be selected as the optimal host for server client requests 121. Similarly, network transmission cost evaluation can calculate the number of hops the network communication must transmit through between two locations. And the member host that requires the least number of hops and the lowest cost of transmission can be selected as the optimal host.

In one embodiment, the optimal host, e.g., host 142, contains the web content or web application that can be utilized to generate a response for the user request 121. After processed the user request, host 142 generates a message 123 as a response to the user request 121 and transmits such message 123 to client 111. From the perspective of client 111, message 123 is received in response to the previous transmitted request 121. Thus, client 111 is shielded from the actual implementation of the web service it requests for. For the member hosts in the environment 170, they can still be used by their respective owners to perform private functions. And only the spare resources will be harvested and utilized by the environment 170 in serving user requests.

In one embodiment, the dynamic web hosting environment 140 allows individual computer system such as new host 143 to be dynamically added to the environment 140. An individual computer system 143 is a computer that is connected to the network 120 and contains sufficient and spare CPU, memory, storage and/or network bandwidth for web content and application hosting. Also, the individual computer system is required to be under the management of the web hosting manager 150, and is accessible from the web by clients 111-112. Examples of suitable computer systems include personal computer, workstations, game consoles, etc. In FIG. 1's example, a new host 143, which is physically located in Asia, is added to the web hosting environment 170 as a member host. Once the new member host 143 is connected and included in the dynamic web hosting environment 170, the dynamic web hosting manager 150 can collect metadata information from the new host 143. Metadata are information about the new host 143, including its geographic location and system resources, etc. The web hosting manager 150 also uploads software applications to the new hosts 143 to ensure that the new host 143 can communicate with other member hosts and respond to client requests.

In one embodiment, once a new host 143 is added to the environment 170 and configured, the dynamic web hosting manager 150 can transfer web contents and web application 160 to the new host 143 based on the web traffic and the overall distribution of such contents in the environment 140. For example, if a client 112, which is located in Asia, is requesting for the web service 130 via message 122, then it would be less efficient to process such request by the hosts 141 and 142, which are not near Asia. Thus, the web hosting manager 150 can determine that the new host 143 is a better candidate for serving Asian clients, and transmit the web contents 160 that are related to the web service 130 to the new host 143 via communication channel 133. Afterward, the web hosting manager 150 can forward the user request 122 to the new host 143. And the new host 143 can generate a response 124 based on the web contents 160 received, and transmit the response 124 “locally” within Asia to the Asian client 112.

In one embodiment, if the member hosts 141-143 contain sufficient CPU, memory, storage and network bandwidth, they can be used to store and run sophisticated web applications. Alternatively, the member hosts can be configured to perform different aspects of the web hosting and application services, such as load balancing, failover, etc. To encourage and support individual users to add their proprietary computer systems to the dynamic web hosting environment 170, a comprehensive compensation model can be deployed to share the profits received from hosting third-party contents and applications among the proprietary computer systems. The details about the dynamic web hosting manager 150 and the dynamic web hosting environment 170 are further described below.

In one embodiment, the dynamic web host manager 150 and/or each of the member hosts 141-143 includes one or more processors 151 and memory 152, etc. The processor(s) 151 may include central processing units (CPUs) for controlling the overall operation of the web hosting manager 150. In certain embodiments, the processor(s) 151 accomplish this by executing software or firmware stored in memory 152. The processor(s) 151 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices. The memory 152 is or includes the main memory of the web hosting manager 150. The memory 152 represents any form of random access memory (RAM), read-only memory (ROM), flash memory (as discussed above), or the like, or a combination of such devices. In use, the memory 152 may contain, among other things, a set of machine instruments which, when executed by processor 151, causing the processor 151 to perform embodiments of the present invention.

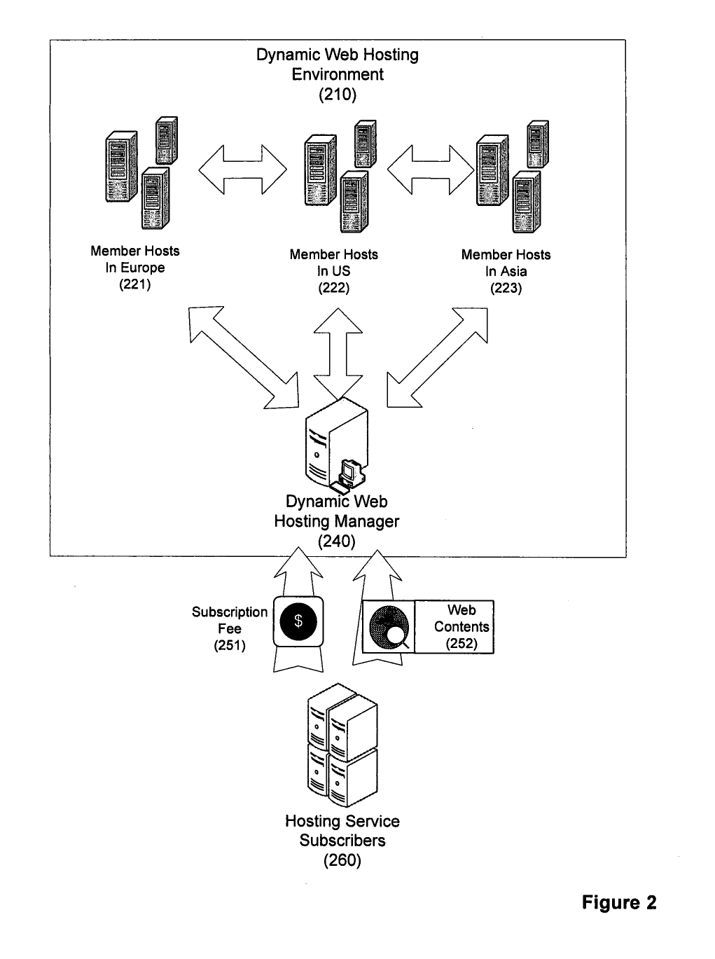

FIG. 2 illustrates an exemplary configuration of a dynamic web hosting environment 210, in accordance with certain embodiments of present invention. The web hosting environment 210 is similar to the environment 170 of FIG. 1. In FIG. 2, multiple member hosts 221-224 have joined the web hosting environment 210, and have been configured to provide services to web clients (not shown). The member hosts 221-224 can be grouped based on their respective geographic locations. In one embodiment, the member hosts not only communicate with the web hosting manager 240, but also interact among the member hosts in a Peer-to-Peer (P2P) fashion. Thus, during user request processing, when one of the member hosts detects that the requested web contents or web resources are not locally available, the member host can initiate a query to locate such contents or resources from peer member hosts. In this approach, the workload on the web hosting manager 240 can be greatly reduced, since not all the communications and processing have to pass through the web hosting manager 240. Alternatively, web contents and/or applications can be replicated among multiple member hosts to provide load balancing and failover. Thus, when one of the member hosts is taken offline by its owner, the web contents and applications could be available and remain accessible from other member hosts.

In one embodiment, third-party content providers 260 can subscribe to the various services provided by the dynamic web hosting environment 210. Third-party content providers can be traditional web business entities such as online media, online stores, etc. They can also be Web 2.0 businesses that provide wikis, blogs, social-networking, multimedia, and other services. Further, the third-party content providers can also be online gaming, and other web-based application platforms. Once subscribed to the services provided by the web hosting environment 210, these third-party content providers become hosting service subscribers 260. The web hosting environment 210 can provide transparent content hosting and delivering to the hosting service subscribers 260, thereby greatly improving the performance and scalability in delivering web contents for the service subscribers 260. The web hosting environment 210 can also greatly reduce the hosting costs comparing to setting up a dedicated infrastructure of network backbones and hosting servers across the Internet. During service subscription, the subscribers 260 can provide the web contents and applications 252 to the web hosting manager 240. Alternatively, the subscribers 260 can also work with the web hosting manager 240 in configuring and managing the web contents and applications for distributing among the member hosts 221-223. During run time, the service subscribers 260 may forward the user requests received from web clients to the web hosting manager 240 for processing.

In exchange for the above web hosting services, the service subscribers 260 can pay subscription fees 251 to the operator of the web hosting environment 210. The subscription fees can be based on the various levels of services a third-party content provider subscribed to. For example, if the content provider would like to have the contents available for fast retrieval throughout the globe, then a higher fee can be collected from the subscriber comparing to a lower level of service. Likewise, if the content provider is only interested in hosting and web site for US users, then only the member hosts that are located in US are utilized, which results in a lower fee. In one embodiment, the fees 251 collected from the subscribers 260 are also distributed among the owners of the member hosts 221-223. By making available of the spare resources, the owners of the member hosts incur operational costs. Further, to encourage more computer systems to join the web hosting environment 210, a fee-distribution scheme provides incentives for the computer owners to contribute the otherwise wasted spare resources of their computers to the web hosting environment 210.

In one embodiment, the collected subscription fees can be shared among the member hosts based on the amount of system resources each of the member hosts contributed. For example, a high-power member host with high throughput web connection can contribute more to the web hosting and content delivering than a low-power low-throughput member host. Therefore, the owner of the high-power member host may receive a higher percentage of fees than the owner of the low-power member host. When a large amount of web traffic is suddenly originated from a specific geographic location, it might take a traditional content providing network months to setup a content delivery infrastructure. In comparison, the dynamic web hosting environment can market a recruitment campaign with a generous compensation plan to quickly attract the individual owners to join their computers to the environment 210 and immediately start providing content distribution. Thus, the dynamic web hosting environment not only can quickly respond to the real-life web traffic demands, but also is robust and efficient in constructing an efficient content delivery infrastructure.

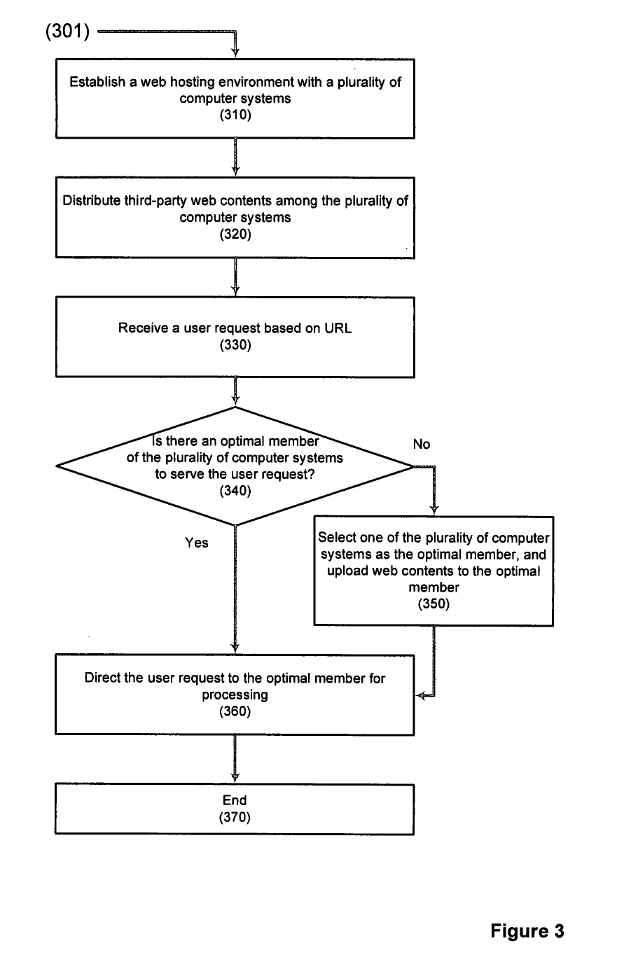

FIG. 3 illustrates an exemplary flow diagram for a method 301 to setup a dynamic web hosting environment, in accordance with certain embodiments of the present invention. The method 301 may be performed by processing logic that may comprise hardware (e.g., special-purpose circuitry, dedicated hardware logic, programmable hardware logic, etc.), software (such as instructions that can be executed on a processing device), firmware or a combination thereof. In one embodiment, method 301 is executable by processor 151 of a dynamic web hosting manager 150 in FIG. 1.

At 310 of FIG. 3, a dynamic web hosting environment is established by a dynamic web hosting manager. The web hosting environment contains multiple computer systems each of which has sufficient and spare CUP, memory, storage and network bandwidth to be used for web content and application hosting. Once becoming a part of the web hosting environment, the individual computer systems are referred to as member hosts. At 320, third-party web contents can be distributed by the web hosting manager to the member hosts. In one embodiment, the distribution of the web contents ensures that the third-party web contents can be efficiently served to the geographic regions that have high demands of such contents. At 330, a user request is received from a client computer seeking access to the web services identified by the URL. The user request can also be relayed from other computers and/or member hosts.

At 340, the user request is forwarded or redirected to the web hosting manager. The web hosting manager identifies the geographic location of the client computer from the user request, and the geographic location of the member hosts that contains the requested web contents. Based on certain criteria, the web hosting manager selects one of the member hosts as the optimal member for serving the user request. In one embodiment, the optimal member host is geographically close in proximity to the client computer. If such optimal member host cannot be located at 340, either due to lacking of such host carrying the requested web contents, or the lacking of a member host that is reasonably close to the client system, the process 301 proceeds to 350. At 350, the web hosting manager selects one of the multiple member hosts as the de facto optimal member, and uploads the requested web contents to such host. Afterward, the member host can be utilized to server any future user requests originated near the geographic location of the client computer. If there is no member host reasonably close-by, the web hosting manager may initiate a subsequent promotion around the client computer's area, hoping to attract additional computer systems to join the environment. Alternatively, the web hosting manager may serve the user request directly by interacting with the third-party content providers and their web sites. At 360, the optimal member for processing the user request is identified, and the user request can be forwarded to the optimal member host for further processing. The member host then generates a response with the requested web contents and transmits the response to the client computer that originated the request. Afterward, process 301 ends at 370.

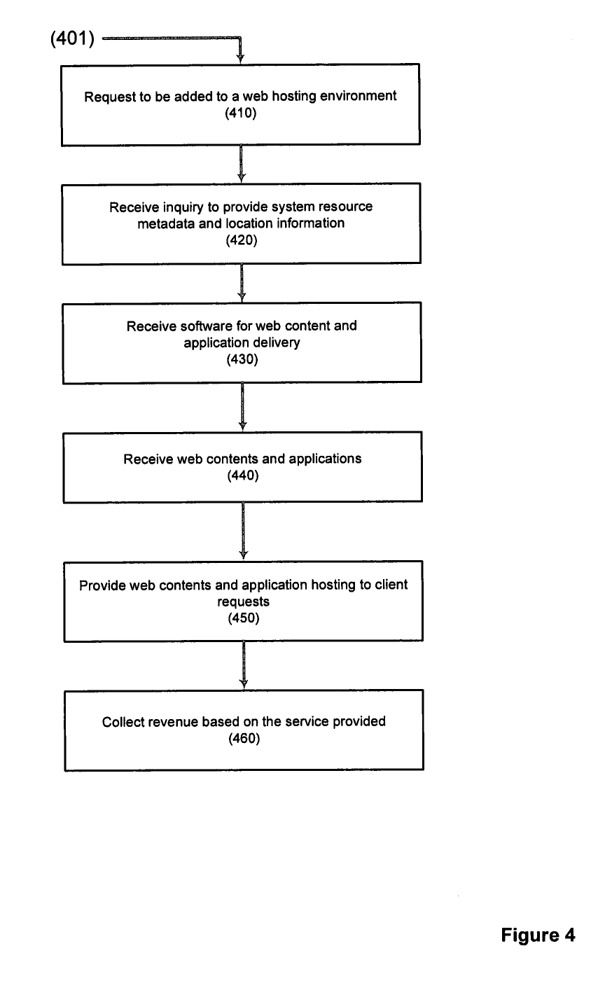

FIG. 4 illustrates an exemplary flow diagram for a method 401 to join a dynamic web hosting environment, in accordance with certain embodiments of the present invention. The method 401 may be performed by processing logic that may comprise hardware (e.g., special-purpose circuitry, dedicated hardware logic, programmable hardware logic, etc.), software (such as instructions that can be executed on a processing device), firmware or a combination thereof. In one embodiment, method 401 is executable by processor 151 of a new member host 143 in FIG. 1.

At 410, an individual computer requests for joining a web hosting environment by communicating with the web hosting manager of the environment. At 420, the web hosting manager inquires the individual computer for its available system resources and the location information. The location information can be utilized for routing user request to such individual computer during content delivering. And the available system resources are spare resources that can be used for web content and application hosting. At 430, software components that are required to manage the individual computer and communicate with other member hosts are downloaded from the web hosting manager and installed in the individual computer. The individual computer becomes a new member host of the dynamic web hosting environment. At 440, web contents and web applications can be loaded by the web hosting manager to the new member host based on past or anticipated web traffic demands. The new member host is passive with respect to the types of web contents and applications it will receive.

At 450, the new member host is now ready to serve the web contents and applications hosted therein based on user requests that are forwarded to it. In one embodiment, the new member host can still be functional to perform other activities for its owner. And only the spare resources on the new member host are harvested by the web hosting environment for providing web hosting and content delivering tasks. At 460, based on the amount of resources provided to the web hosting environment, the new member host is entitled to collect a share of revenue generated by the web hosting environment. The revenue is also dependent on the total amount of profits the web hosting environment generates and the agreements between the new member host and the environment during signing up.

Thus, methods and systems for implementing a dynamic web hosting and content delivering environment have been described. The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable medium and may be executed by one or more general-purpose or special-purpose programmable microprocessors. A “machine-readable storage medium”, as the term is used herein, includes any mechanism that provides (i.e., stores and/or transmits) information in a form accessible by a machine (e.g., a computer, network device, personal digital assistant (PDA), manufacturing tool, any device with a set of one or more processors, etc.). For example, a machine-accessible medium includes recordable/non-recordable media (e.g., read-only memory (ROM); random access memory (RAM); magnetic disk storage media; optical storage media; flash memory devices; etc.), etc.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method, comprising:
establishing a computer environment with a plurality of computer systems each of which is dynamically added to the computer environment;
distributing third-party web contents among the plurality of computer systems; and
upon receiving a URL request from a client system, directing the URL request to a member host selected from the plurality of computer systems, wherein the member host contains the web contents for the URL request, and is optimal in serving the URL request.

2. The method as recited in claim 1, wherein the member host is optimal in serving the URL request due to its close in proximity to the client system.

3. The method as recited in claim 1, further comprising:
dynamically adding a computer system as a new member host to the plurality of computer systems in the computer environment.

4. The method as recited in claim 2, further comprising:
allowing the computer system to share revenue generated from hosting the third-party web contents among the plurality of computer systems.

5. The method as recited in claim 1, wherein the member host acts as an edge server for a web site identified by the URL request.

6. The method as recited in claim 1, wherein the member host acts as a part of a cloud computing configuration.

7. A system, comprising:
a plurality of computer systems each of which is dynamically added to the system; and
a dynamic web hosting manager coupled with the plurality of computer systems, wherein the dynamic web hosting manager distribute third-party web contents to the plurality of computer systems, and upon receiving a user request from a client system for the web contents, the dynamic web hosting manager directs the user request to one of the plurality of computer systems that is geographically close in proximity to the client system.
